(19) United States
(12) Patent Application Publication
(10) Pub. No.: US 2019/0274263 A1
(43) Pub. Date: Sep. 12, 2019

(54) GROUND ANCHOR

(71) Applicant: Michigan Hop Products, Custer, MI (US)

(72) Inventor: Scott Mast, Custer, MI (US)

(21) Appl. No.: 16/297,134

(22) Filed: Mar. 8, 2019

Related U.S. Application Data
(60) Provisional application No. 62/641,386, filed on Mar. 11, 2018.

(51) Int. Cl. A01G 9/12; C09K 17/18; C05F 11/00

(52) U.S. Cl. CPC A01G 9/12; A01C 15/00; C05F 11/00; C09K 17/18

(57) ABSTRACT

A ground anchor for securing one end of a string or twine in the ground, so as to provide structural support via the string or twine when other portion of string or twine extends to and is secured at another point above ground. The ground anchor can be used for agricultural applications, relating to structural configurations in which vertical support is warranted for plants during their growth, such as for hop plants. The ground anchor can be formed of biodegradable material to break down following a period of time after the anchor is implanted in the ground. The biodegradable material can involve or include a nutrient resin which releases into the ground for soil nourishment following a period of time after the anchor is implanted in the ground.

### RELATED MATTERS

The present application claims the benefit of U.S. Provisional Patent Application No. 62/641,386, filed Mar. 11, 2018, the contents of which are incorporated herein by reference.

### FIELD OF THE INVENTION

The present invention generally relates to apparatus for enabling structural support, and methods of use of the same. More particularly, this invention relates to agricultural applications, and ground anchors for enabling structural support for plants during their growth.

### BACKGROUND

In agricultural applications, there are certain plants known to exhibit superior growth patterns when provided with structural support during their growth cycle. One such plant is the hop, whereby a technique known as stringing and trellising is conventionally used to provide such support as the plant grows upward from the soil. With certain set-ups, the technique involves spacing poles along every row of hop plants, and then running cable wire at elevated height across each row of poles, forming one or more trellis lines thereon that are generally parallel to the hop plants thereunder. In turn, stringing of the trellis is performed. Particularly, spaced along the cable (or top) wire are a series of strings, traditionally, coir twine. These lengths of coir twine are typically attached (e.g., knotted) to the cable wire, with opposing ends of the twine extending downward from the wire and being anchored to the soil.

A conventional method of anchoring the coir twine to the soil has involved the use of a “w” shaped clip, depicted in FIG. 1 and referenced as 10. Typically, the clip 10 is inserted in the soil (generally, about 12″ to 16″ below ground level) via use of a tool 12, a lower portion of which is further shown in FIG. 1. For example, following attachment of a length of coir twine to the cable (or top) wire, a portion of the twine is drawn to extend through the “v” shaped middle loop 14 of the “w” clip 10, where after the clip 10 is driven into the soil via vertical downward force applied to the clip 10 upon being fastened to the tool 12. Upon being driven in such manner into the soil, the twine extending between the top wire and the clip 10 becomes taut to provide a vertically-extending structure for support of shoots of the hop plant during the plant's growth.

While the above-described “w” type clips have provided a means for enabling structural support for the plants, their use has not been without issue. For example, despite the clips being formed of steel, due to their thin profile, they can be found to easily shift during their implantation into the soil. For example, the clips can be found to loosen from the end of the implant tool, resulting in movement of the clip, thereby compromising the clip's positioning in the soil. As would be appreciated, the outer legs of the “w” shaped clip play an important role in maintaining the clip's position in the soil so as to correspondingly maintain tautness on the twine. To that end, inadvertent movement of the clip during implantation can result in the need to repeat such step until positioning of the clip is as desired.

In light of the above, a few alternative anchoring configurations have surfaced. For example, instead of using the “w” shaped clips, ground stakes or an additional off-the-ground cable line have been used, to which the twine end can be attached, rather than implanting the twine in the soil. Such practices are still used in some applications, but large farms have encountered issues, particularly with end-of-season cleanup, as the stakes or the additional cable get in the way of mowing and other clean up activities of the hop plant areas. Due to this as well as other reasons, anchoring the coir twine in the soil via use of the “w” shaped clips is still widely practiced. However, following implantation, one is left with significant quantities of steel clips in the soil for an extended period of time, during which the clips can start to decay. Any such decay is clearly not ideal for growing environments. Despite this, the price point for the “w” shaped clip is relatively low, which takes on significance in light of the large quantities that are used by hop plant farmers. Thus, to date, despite the above-described issues (as well as others), the agricultural industry has continued its use of the “w” shaped clips.

Embodiments of the invention are focused on addressing these issues and other challenges in providing a new design of ground anchoring mechanism.

### SUMMARY OF THE INVENTION

Embodiments of the invention are drawn to ground anchors intended for being driven into the soil and establishing a means for securement of string or twine extending therefrom. In some cases, the ground anchors can be used for agricultural applications, particularly relating to structural configurations in which vertical support is warranted for plants during their growth. Such applications can be wide-ranging—from home use, such as with gardens, to more quasi-home/commercial use, such as with greenhouses, and even to mass production via the food industry, such as in the case of wide-scale, large acreage farms. In one particular application, the ground anchor can be used with hop plants, for securing coir twine at one end within the soil, with other end of such twine being attached to an elevated cable wire, in order for the twine to provide structural support for the hop plant during its growth.

In one embodiment, a ground anchor for enabling structural support between ground and elevated positions is provided. The ground anchor comprises a solid body having shape of an arrow head. The body has angled opposing sides that are offset on one end of the body by a recess and on other end of the body by a solid stem form that protrudes from the body. The recess defines a channel extending crosswise between the sides of the body and is configured to accommodate a string or twine extending from the elevated position and is drawn through the channel for securement therein when the body is implanted in the ground.

In another embodiment, a ground anchor for enabling structural support between ground and elevated positions is provided. The ground anchor comprises a solid body configured for securing a string or twine extending from the elevated position when the body is implanted in the ground. The body has a back or driving end comprising a solid stem form integral with yet protruding from the body and is configured for linkage with an implantation tool. The body is formed of biodegradable material to break down following a period of time after the body is implanted in the ground.

In a further embodiment, a ground anchor for enabling structural support between ground and elevated positions is provided. The ground anchor comprises a solid body configured for securing a string or twine extending from the elevated position when the body is implanted in the ground. The body comprises a solid stem form protruding from the body and is configured for linkage with an implantation tool. The body is formed of biodegradable material to break down following a period of time after the body is implanted in the ground.

### BRIEF DESCRIPTION OF THE DRAWINGS

The following drawings are illustrative of particular embodiments of the present invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a side view of a conventional “w” shaped clip shown mounted on an exemplary insertion tool;

FIG. 2 is an elevation view of a ground anchor in accordance with certain embodiments of the invention;

FIG. 3 is a bottom view of the ground anchor of FIG. 2, showing an exemplary configuration of a stem of the anchor;

FIG. 4 is a side perspective view of the ground anchor of FIG. 2;

FIG. 5 shows a flowchart for one method of using the ground anchor of FIG. 2 formed of one or more materials in certain embodiments of the invention;

FIG. 6 shows a flowchart for another method of using the ground anchor of FIG. 2 formed of an alternate set of one or more further materials in certain embodiments of the invention; and

FIG. 7 shows a flowchart for another method of using the ground anchor of FIG. 2 formed of an alternate set of one or more even further materials in certain embodiments of the invention.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and other elements employ that which is known to those of ordinary skill in the field of the invention. Those skilled in the art will recognize that many of the noted examples have a variety of suitable alternatives.

As noted above, embodiments of the invention are drawn to ground anchors for securing one end of a string or twine in the ground, so as to provide structural support via the string or twine when other portion of string or twine extends to and is secured at another point above ground. In some cases, the ground anchors can be used for agricultural applications, particularly relating to structural configurations in which vertical support is warranted for plants during their growth. In one particular application, the ground anchor can be used for securing coir twine at one end within the soil, with other end of such twine attached to an elevated cable wire, in order for the twine to provide structural support for a hop plant during its growth.

An exemplary technique of stringing and trellising relative to hop plant applications has already been described. To that end, similar steps would be followed up to the stage of anchoring the coir twine to the ground. At that point, and in accordance with embodiments of the invention, ground anchors would be used instead of the conventional “w” shaped clips. FIGS. 2, 3, and 4 show elevation, bottom, and side perspective views, respectively, of such a ground anchor 20 in accordance with certain embodiments of the invention. As illustrated, the ground anchor 20 is formed of a solid body 22 having general shape of an arrow head. To that end, the body 22 has angled opposing sides 24, 26 that are offset on one end of the body 22 by a recess 28 and on the other end by a stem 30 that protrudes from the body 22. In certain embodiments, the ground anchor 20 stands between 1″ and 1.5″ tall, between 0.75″ and 1.25″ wide, and between 0.1″ and 0.5″ thick. In more preferable embodiments, the anchor 20 stands between 1.25″ and 1.5″ tall, between 0.85″ and 0.1.15″ wide, and between 0.2″ and 0.4″ thick. In one particularly preferable embodiment, for example, the anchor 20 stands about 1.3″ tall, about 1″ wide, and about 0.3″ thick.

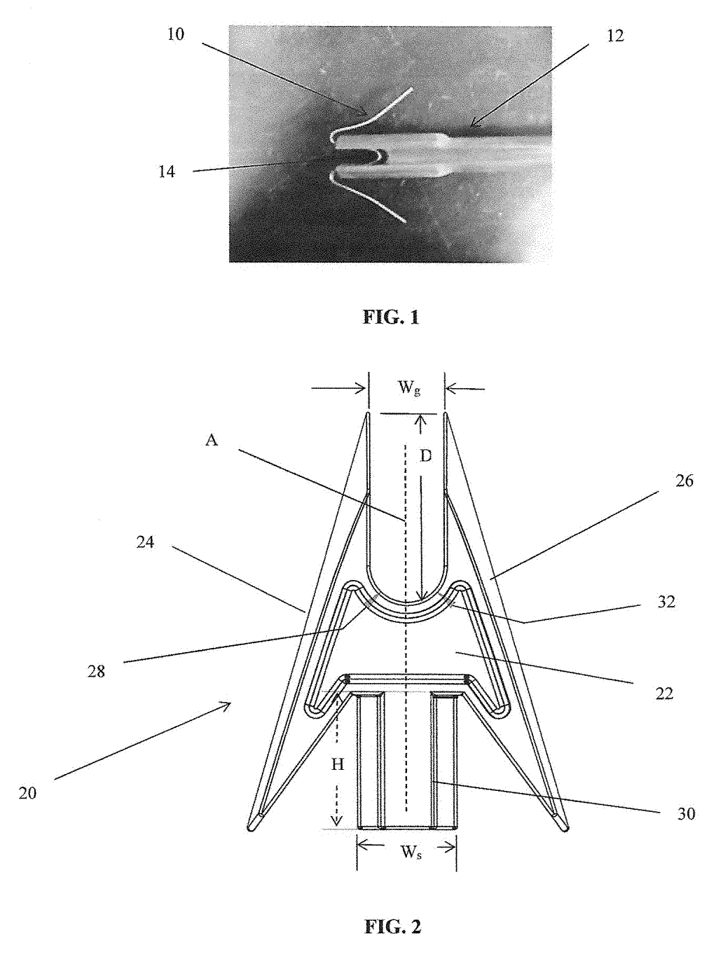

The different portions of the ground anchor 20 are now detailed in reference to use of the anchor 20. As noted above, the ground anchor 20 is configured for being driven into/implanted in the ground (soil) for securing string (such as coir twine) joined with the anchor 20 in the process. In certain embodiments, such implanting of the anchor 20 can be provided via an implantation tool. With reference back to FIG. 1, a tool used with the ground anchor 20 can be of similar configuration as is shown for the tool 12. To that end, the stem 30 of the anchor 20 has a configuration which can be received in a recess at a driving end of an implantation tool. Thus, the stem 30 serves as the back (or driving) end of the ground anchor 20, while the sides 24, 26 and recess 28 collectively serve as the front (or driven) end.

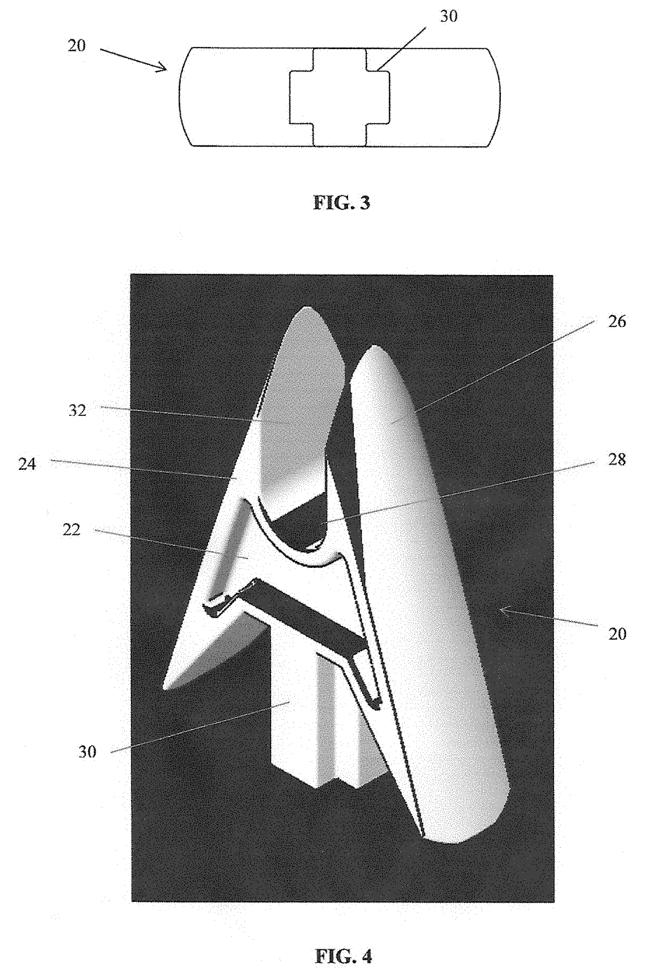

Continuing with the above, in certain embodiments as shown in FIG. 2, the stem 30 is substantially aligned with the recess 28, and centered along a longitudinal midline A of the body 22, relative to the sides 24, 26 of the anchor 20. As described above, the stem 30 protrudes from the body 22 of the ground anchor 20, and, in certain embodiments as shown, is integral therewith. The stem 30 is formed to be of substantial size, relative to the other portions and overall length of the anchor 20. For example, the stem 30 has a width Wₛ that exceeds a width Wᵣ of the recess 28, and has a height H that is at least a quarter of the total longitudinal extent of the anchor 20. Consequently, the stem 30 can enable secure fitting/linkage with an implantation tool, but also exhibit enhanced tensile strength (when enduring the downward driving force via the implanting tool) and shear strength (particularly as such driving force is counteracted by the static force of the soil through which the anchor 20 is driven). To further minimize incidence of shifting relative to an implantation tool, in certain embodiments, the stem 30 can have a particular profile, so as to specifically mate with corresponding recess at the receiving end of the implantation tool. For instance, as best shown in FIG. 3, the profile of the stem 30 can be in the shape of a cross; however, the invention should not be limited to such.

Turning to the other portions of the ground anchor 20, and particularly the angled sides 24, 26 and recess 28 collectively serving as the front (or driven) end of the anchor 20, they are configured to function in various ways in securing coir twine therewith. Starting with the recess 28, as shown, it defines a “u” shaped channel 32 through which the coir twine can be drawn. To that end, as the recess end of the ground anchor 20 is driven into the soil, the soil fills the recess 32, contacting and pushing the twine against inner wall defining the channel 32 such that the twine locks in place in the channel 32. Accordingly, with other portion of the twine attached to cable or top wire (as previously described), the twine becomes taut between the anchor 20 and cable wire. Shifting to the angled sides 24, 26 of the ground anchor 20, as the recess end of the anchor 20 is driven into the soil, the pointed ends of the sides 24, 26 work collectively in cutting into the soil, and directing soil into the recess 28 as well as along the sides 24, 26, away from the recess 28. In certain embodiments, exterior walls of the sides 24, 26 extend outward at angle between 20° and 40° relative to their corresponding interior walls (defining the channel 32). In preferable embodiments, the exterior walls of the side 24, 26 extend outward at an angle of about 30° relative to their corresponding interior walls.

As described above, the ground anchor 20 is formed of a solid body 22 with its sides 24, 26 and stem 30. For example, in certain embodiments, the anchor 20 can be formed via an injection molding process. Via its solid finished form, and in comparison to the “w” shaped clip, the anchor 20 is not only better configured for linkage with implantation tool, but also for absorbing and deflecting impact from a wide variety of soil types, with minimized impact on its form when implanted. The ground anchor 20 is further found to hold form when subjected to forces once implanted. For example, when a pulling force acts on the secured coir twine, the anchor 20 is configured to be impacted as one body, so as to pivot in the direction of the force. As a result, the corresponding side 24 or 26 of the ground anchor is rotated as to have more of a flattened orientation to the soil above the anchor 20, thereby better fixing the anchor's position in the soil while maintaining tautness on the twine.

As should be further appreciated, and again in comparison to the conventional “w” shaped clip, while the sides 24, 26 of the ground anchor 20 are offset by the recess 28 at its front (or driven) end, it perhaps is a more accurate description that the recess 28 and channel 32 thereof are in part defined by the sides 24, 26. By way of comparison, the stem 32 protrudes/extends from the body 22, in direction opposite the recess 28. With reference back to FIG. 2, in certain embodiments as shown, the depth D of the recess 28 is more than a third of the longitudinal extent of the anchor 20. Accordingly, the recess 28 provides a sufficiently-deep reservoir to accommodate a strand of coir twine. However, due to the spacing between recess 28 and stem 30, a coir twine would resultantly be implanted deeper in the soil via the ground anchor 20, as compared to a “w” shaped clip driven to same depth, because the “w” shaped clip uses its “v” shaped middle loop 14 (see FIG. 1) as both recess and stem. As such, not only can the ground anchor 20 provide a more effective mechanism for being implanted and securing coir twine as compared to the “w” shaped clip (for reasons already noted above), but also a more efficient mechanism.

Turning back to fabrication, as described, the ground anchor 20 can be formed via injection molding. In certain embodiments, the anchor 20 is formed from biodegradable material. To that end, not only can the ground anchor 20 provide a more effective and efficient mechanism (as compared to the “w” shaped clip), but the anchor 20 can be environmentally friendly as well. For example, the material, in certain embodiments, can involve or include a resin material, e.g., poly lactic acid (PLA)/poly butylene succinate (PBS) non-contaminate resin material. Such PLA/PBS material is commercially available, for example, from Algix Company, principally located in Meridian, Miss., or Nexo Solutions, principally located in The Woodlands, Tex. And, while the material has begun to be recognized as a novel solution for food packaging applications, it would be equally applicable in this application of plant/food growth, such as with hop plants. Particularly, growth of cones from hop plants is most prevalent during the plant's growth from April to October. Thus, at the back end of this growth period, the ground anchor 20, in being formed of biodegradable material, would start to break down in an environmentally safe manner, thereby leaving no trace in the ground for future planting seasons.

In certain embodiments, during the ground anchor's fabrication, the base material used in forming the anchor 20 is incorporated with one or more nutrients. To that end, the one or more nutrients can be characteristic of the base biodegradable resin material, or can be further added to such material. In either case, in forming the ground anchor 20 via such engrained or enriched biodegradeable material, in the process of that base material breaking down, the one or more nutrients are released, enriching the soil for future planting seasons. In certain embodiments, the one or more nutrients can be incorporated with the biodegradable base material in the form of an algae-based resin from which, when the biodegradable material breaks down, the one or more nutrients of the resin (e.g., nitrogen, phosphorous, and/or other micronutrients) can release into the soil. It should be appreciated that these nutrients can be of particular value in keeping the soil at a base neutral toxicity, which is ideal for future planting seasons. In certain embodiments, the ratio between the base biodegradable material and the nutrient resin (e.g., algae resin), when such resin is added to the base material, ranges between 85%/15% and 70%/30%; however, such ratio can also be outside this range, depending in large part on how quickly one wants the ground anchor 20 to biodegrade. It should be further appreciated that while an algae-based resin is exemplified, one could also just as well use other resin variations for or with the anchor, such as a wood-based resin. Also, providing nutrients back to the soil can expand beyond the ground anchor 20, for example, including the coir twine as well. For example, in certain embodiments, the twine used could be formed of coconut coir, which would further provide nutrient value to the extent of the coir twine that is implanted in the soil.

Thus, in many ways as described herein, the ground anchor 20 shown in FIGS. 2-4 can be an effective and efficient alternative to the “w” shaped clip conventionally used in the agricultural industry, with one application being in relation to hop plants and structural support provided therefor during the plant's growth. For example, via its solid rigid body and corresponding portions (sides 24, 26 and stem 30) sharing the same characteristics, the ground anchor 20 can be effectively implanted in a variety of soil types and maintain its securement of coir twine drawn to the anchor 20 once implanted. Furthermore, the ground anchor 20 is configured to implant a strand of coir twine deeper relative to spacing of its recess 28 and stem 30, so as to function more efficiently. Such characteristics, in certain embodiments, can carry forth using different materials in fabricating the anchor 20. For example, the ground anchor 20 can be formed of a biodegradable material so as to break down over time and thus not leave any metal signature in the vicinity of plants cultivated in later growing seasons. Furthermore, when fabricated, the base material of the anchor 20 can be integrated with nutrient resin so as to be added to the soil for future growing seasons, e.g., with the nutrients providing a soil environment prone for enhancing plant growth, both root and foliar. In particular, when such nutrient resin is characteristic of or further added to a biodegradable base material for the ground anchor 20, the nutrients can effectively release into the soil at the stage of environmental breakdown of the base material.

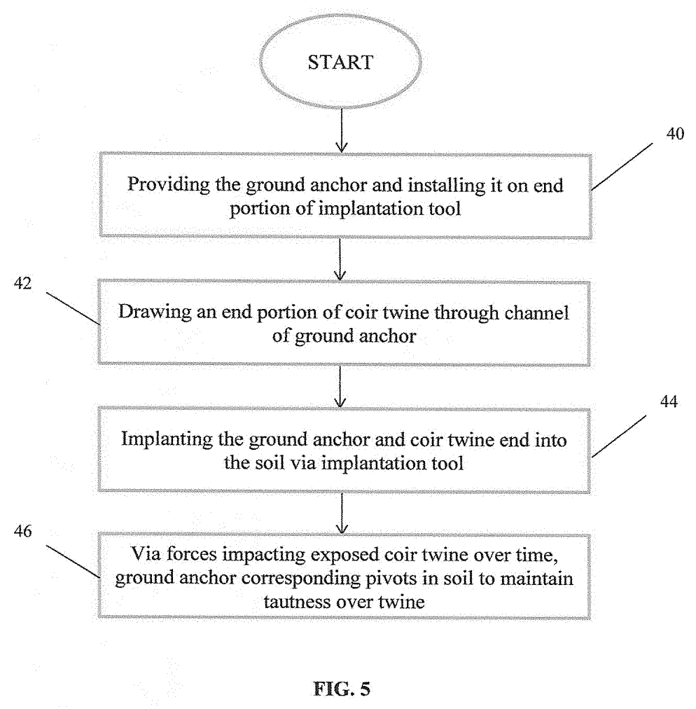

FIGS. 5, 6, and 7 show flowcharts of exemplary methods of use of the ground anchor 20 in hop planting applications. Starting with FIG. 5, its flowchart involves the ground anchor 20 when formed of one or more non-biodegradable materials. To that end, and starting at the stage at which the poles and cable (or top) wire have been installed and the coir twine has been attached (e.g., knotted) to such wire, an initial step 40 involves providing the ground anchor 20 and installing it on end portion of implantation tool. As described herein, the stem 30 of the anchor 20 is configured to be snugly secured within a recess at the tool end portion, whereby the stem can furthermore be formed to have particular profile so as to mate particularly in the tool recess. Step 42 involves drawing an end portion of the coir twine through the channel 32 of the anchor 20, while step 44 involves implanting the ground anchor 20 and coir twine end into the soil via the implantation tool. Such implantation generally involves the anchor 20/twine end being driven 12″ to 16″ below ground level, at which point the extent of the twine exposed between ground anchor 20 and the cable wire become taut. As already described, over time after the anchor 20/twine end are implanted, various forces may impact the exposed extent of the twine at step 46. To that end, with the introduction of such forces, the ground anchor 20 may be found to pivot in the soil (via force on twine acting on inner wall of the channel 32 of the anchor 20), whereby the corresponding side 24 or 26 rotates so as to be have more of a flattened orientation within the soil, thereby providing and maintaining a tautness on the twine.

Moving on to FIG. 6, its flowchart involves the ground anchor 20 being formed of biodegradable materials. To that end, the steps of the flowchart can continue from the last stage of FIG. 5, whereby at step 50, a certain period of time has passed following the ground anchor's initial implantation, at which point the biodegradable material starts to degrade. As described above, the biodegradable material can involve or include a nutrient resin. It should be appreciated that the timing for such material degradation would be planned in concert with the growth season of the hop plant. For example, given that the hop plant season generally runs from April to October, the biodegradable material can be selected such that its degrading cycle starts perpetuating after six months' time (in late September), whereby at step 52, decay of the material would have reached a stage whereby the coir twine can be readily pulled from the anchor 20 during season clean up.

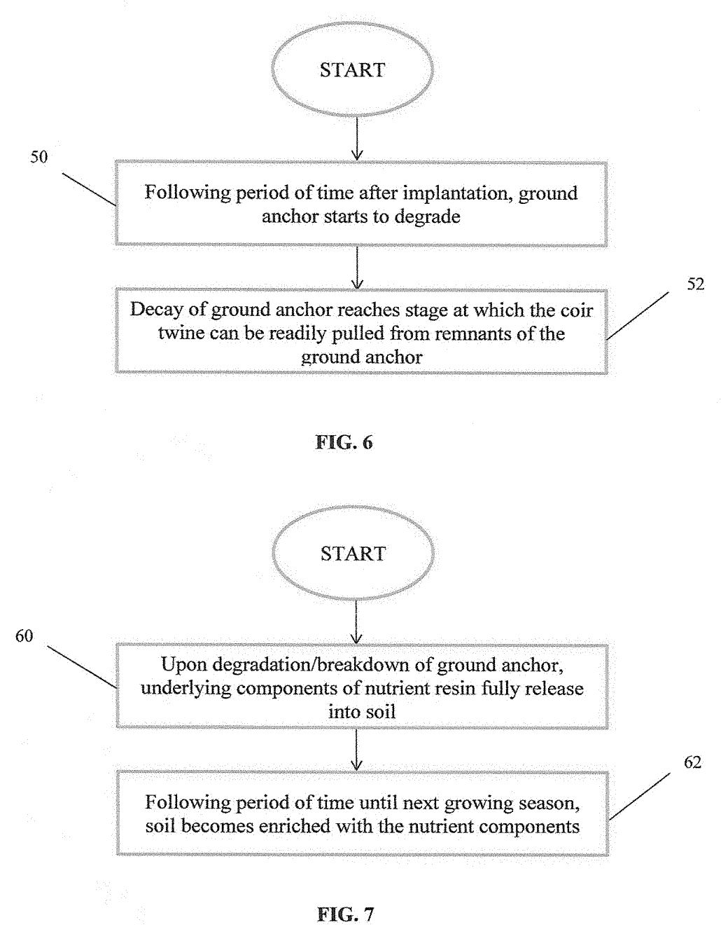

Regarding the flowchart of FIG. 7, it involves the ground anchor 20 formed of a nutrient resin, either characteristic of or further added to biodegradable material for the anchor. As already noted, this can involve the ground anchor 20 being formed of a ratio of biodegradable material and nutrient resin. To that end, the steps of the flowchart can continue from the last stage of FIG. 6, whereby at step 60, upon the degradation and breakdown of the biodegradable material of the anchor 20 within the soil, the underlying components of the nutrient resin fully release into the soil. In turn, at step 62, upon passage of time until the next growing season, the soil becomes enriched with such nutrient components, so as to provide better soil conditions for enhanced growth for the following planting season.

Thus, embodiments of GROUND ANCHOR are disclosed. One skilled in the art will appreciate that the invention can be practiced with embodiments other than those disclosed. The disclosed embodiments are presented for purposes of illustration and not limitation, and the invention is limited only by the claims that follow.

What is claimed is:

1. A ground anchor for enabling structural support between ground and elevated positions, comprising a solid body having shape of an arrow head, the body having angled opposing sides that are offset on one end of the body by a recess and on other end of the body by a solid stem form that protrudes from the body, the recess defining a channel extending crosswise between the sides of the body and configured to accommodate a string or twine extending from the elevated position and being drawn through the channel for securement therein when the body is implanted in the ground.

2. The ground anchor of claim 1 wherein the stem form is integral with and comprises a portion of the body.

3. The ground anchor of claim 1 wherein the stem form is substantially aligned with the recess and centered along a longitudinal midline of the body.

4. The ground anchor of claim 3 wherein the stem form represents a driving end of the body, and the sides and the recess collectively represent a driven end of the body, the stem form being spaced a distance from the recess such that the channel is correspondingly spaced deeper than the stem form when the body is implanted in the ground.

5. The ground anchor of claim 1 wherein the stem form is configured for linkage with an implantation tool, the stem form defined to have a particular profile to mate with a corresponding shape of recess defined at a driving end of the tool.

6. The ground anchor of claim 5 wherein the profile of the stem form is in a shape of a cross.

7. The ground anchor of claim 1 wherein the stem form has a greater width than that of the channel of the recess.

8. The ground anchor of claim 1 wherein the channel is defined to be in the shape of a “u.”

9. The ground anchor of claim 8, wherein the channel is in part defined by the interior walls of the sides, and wherein exterior walls of the sides extend outward at an angle between 20° and 40° relative to their corresponding interior walls.

10. The ground anchor of claim 1 wherein the body is formed of biodegradable material.

11. The ground anchor of claim 1 wherein the body is formed of a nutrient resin which releases into the ground for soil nourishment following certain period of time after the body is implanted in the ground.

12. A ground anchor for enabling structural support between ground and elevated positions, comprising a solid body configured for securing a string or twine extending from the elevated position when the body is implanted in the ground, the body having a back or driving end comprising a solid stem form integral with yet protruding from the body and configured for linkage with an implantation tool, the body being formed of biodegradable material to break down following a period of time after the body is implanted in the ground.

13. The ground anchor of claim 12 wherein the body has a front or driven end formed with a recess defining a channel for accommodating the string or twine, the stem form substantially aligned with and spaced a distance from the recess.

14. The ground anchor of claim 12 wherein the stem form is defined to have a particular profile to mate with a corresponding shape of recess defined at a driving end of the tool.

15. The ground anchor of claim 12 wherein the biodegradable material is incorporated with one or more nutrients which release into the ground for soil nourishment following the period of time.

16. The ground anchor of claim 15 wherein the one or more nutrients are characteristic of the biodegradable material.

17. The ground anchor of claim 12 wherein the biodegradable material involves or includes a poly lactic acid (PLA)/poly butylene succinate (PBS) non-contaminate resin material.

18. A ground anchor for enabling structural support between ground and elevated positions, comprising a solid body configured for securing a string or twine extending from the elevated position when the body is implanted in the ground, the body comprising a solid stem form protruding from the body and being configured for linkage with an implantation tool, the body being formed of biodegradable material to break down following a period of time after the body is implanted in the ground.

19. The ground anchor of claim 18 wherein the biodegradable material is formed of a nutrient resin which releases into the ground for soil nourishment following the period of time.

20. The ground anchor of claim 18 wherein the stem form is defined to have a particular profile to mate with a corresponding shape of recess defined at a driving end of the tool.
